(19) United States
(12) Patent Application Publication
(10) Pub. No.: US 2018/0341482 A1
(43) Pub. Date: Nov. 29, 2018

(54) METHOD AND ARRANGEMENT FOR UTILIZATION OF A PROCESSING ARRANGEMENT

(71) Applicant: TELEFONAKTIEBOLAGET LM ERICSSON (PUBL), Stockholm (SE)

(72) Inventors: Amir ROOZBEH, Kista (SE); Daniel TURULL, Sundbyberg (SE); Joao MONTEIRO SOARES, Solna (SE)

(21) Appl. No.: 15/777,741

(22) PCT Filed: Dec. 18, 2015
(86) PCT No.: PCT/EP2015/080675

§ 371 Date: May 21, 2018

(51) Int. Cl. G06F 9/30; G06F 9/50; G06F 1/32

(52) U.S. Cl. CPC G06F 9/3009; G06F 1/3287; G06F 9/5011

(57) ABSTRACT

It is disclosed a processing arrangement utilizing function capable of efficiently utilizing a processing arrangement and a method performed therein, where the processing arrangement comprises a first and a second physical processing unit, PU, where the first physical PU is adapted to be assigned to a first logical PU. When the first physical PU is turned off, it may be assigned to another logical PU in need to be activated. When the first logical PU needs to be activated, it can be assigned to a second physical PU. A notification is sent to a power management unit to activate the physical PU to which a logical PU is assigned. Embodiments of this disclosure increase the utilization of processing arrangements, taking advantage of statistical multiplexing.

### TECHNICAL FIELD

This disclosure relates to utilization of processing arrangements. More particularly, it relates to a method and an arrangement for utilization of processing arrangements.

### BACKGROUND

Modern processing arrangements, such as central processing units (CPUs) have different features to reduce power consumption when there are no instructions to be executed by the CPUs. CPUs can enter an idle power saving state (C-state), or an execution power saving state (P-state).

Idle or sleeping power-saving states affect various levels of processing arrangements. One mechanism turns off different circuitry in order to save power.

Execution power saving states, or P-states, cover all circuitry inside a processing arrangement, where the processing arrangement may be a group of processing cores, sharing some basic functions. A P-state adapts processing frequency and applied voltage within the processing arrangement.

Turning off part of a chip saves power but increase the latency since some time is needed to turn the chip on again and restore the architectural state of the chip from the time of the turning off the part of the chip. The architectural state of the chip is typically saved in a static memory when turning off at least part of a chip.

Whether to go enter a deep sleep state or not, is taken by a power management unit. Waking up from such a state may be based on interrupt instructions or signals from an operative system.

Within a CPU, it is the power management system that controls the management of the power saving states as a function of the utilization of the CPU.

Data centers traditionally comprise a number of servers wherein each server contains a single motherboard that may be integrated with various resources.

FIG. 1 schematically presents such various resources in the form of processing units, such as processor cores; memory units such as random access memory (RAM) units; networking, such as a network interface card (NIC); and storage units, handled by an input/output handler. The resources are herein interfaced to a data communication network (DC NW) via by the NIC.

In order to provide resource sharing and increase of resource utilization data center providers may employ computer virtualization.

Computer virtualization is a technique that abstracts different hardware parts of a computer platform and allows execution of different operating systems.

There are several ways of virtualizing a computational system, where a commonly used way is the one that uses a virtual machine monitor (VMM), sometimes also called hypervisor. The hypervisor may be considered to be a layer of software that provides to a virtual machine the illusion that it is running its own resources. By using such means, multiple operating systems and applications can run on the same server while sharing resources of one and the same physical server.

It is further noted that recent data center hardware architectures rely on the principle of hardware resource disaggregation, which considers processing arrangements such as CPUs, memory and network resources as individual and modular components. These resources may moreover be organized in groups or pools, i.e. pools of CPU units, pools of memory units, and pool(s) of network interfaces. In this sense, a host may be logically composed of a subset of units/resources from one or more pools, which enables execution of instructions by a subset of units/resources of each host.

There is however a demand for an improved resource utilization of processing arrangements.

### SUMMARY

It is an object of exemplary embodiments herein to address at least some of the issues outlined above and to efficiently utilize a processing arrangement. This object and others are achieved by a processing arrangement utilizing function, and a method performed therein, according to the appended independent claims, and by the exemplary embodiments according to the dependent claims.

According to an aspect, the exemplary embodiments provide a method for efficient utilization of a processing arrangement that comprises at least a first and a second physical processing unit, where the first physical processing unit is assigned to a first logical processing unit. The method comprises obtaining information that the first physical processing unit is turned off. The method also comprises, when another logical processing unit is to be activated, assigning said first physical processing unit to said another logical processing unit. The method also comprises, when said first logical processing unit is to be activated, assigning said second physical processing unit to the first logical processing unit. In addition, the method comprises sending, to a power management unit, a notification to activate the first physical processing unit when being assigned to said another logical processing unit and to activate the second physical processing unit when being assigned to said first logical processing unit.

According to another aspect, the exemplary embodiments provide a processing arrangement utilizing function that is capable of efficiently utilizing a processing arrangement that comprises at least a first and a second physical processing unit, where the first physical processing unit is adapted to be assigned to a first logical processing unit. The processing arrangement utilizing function is configured to obtain information that the first physical processing unit is turned off. The processing arrangement utilizing function is also configured to, when another logical processing unit is to be activated, assign said first physical processing unit to said another logical processing unit. The processing arrangement utilizing function is also configured to, when said first logical processing unit is to be activated, assign said second physical processing unit to the first logical processing unit. In addition, the processing arrangement utilizing function is also configured to, send to a power management unit, a notification to activate the first physical processing unit when being assigned to said another logical processing unit and to activate the second physical processing unit when being assigned to said first logical processing unit.

According to another aspect, the exemplary embodiments provide a processing arrangement utilizing function that is capable of efficiently utilizing a processing arrangement. The processing arrangement utilizing function comprises a processing circuit, and a memory. The memory contains instructions executable by said processing circuitry whereby said processing arrangement utilizing function is operative to obtain information that the first physical processing unit is turned off. The processing arrangement utilizing function is also operative to, when another logical processing unit is to be activated, assign said first physical processing unit to said another logical processing unit. The processing arrangement utilizing function is also operative to, when said first logical processing unit is to be activated, assign said second physical processing unit to the first logical processing unit. In addition, the processing arrangement utilizing function is operative to, send to a power management unit, a notification to activate the first physical processing unit when being assigned to said another logical processing unit and to activate the second physical processing unit when being assigned to said first logical processing unit.

According to further aspects, the object is also achieved by a computer program and a computer program product comprising a computer-readable storage medium corresponding to the aspects above.

Exemplary embodiments of this disclosure present the following advantages:

The present invention enables improved utilization of processing arrangements, by allowing idle processing arrangements to be utilized by logical processing units (PUs). By dynamically assigning physical PU, logical PU can be activated and maintaining unused physical PUs turned off, is avoided. Physical PUs of one and the same CPU pool may be shared with other hosts using the same CPU pool. Embodiments increase the dynamicity of the assignment of the CPUs. This invention takes advantage of statistical multiplexing since multiple physical PUs will typically be comprised in processing arrangements, such as CPU pools.

### BRIEF DESCRIPTION OF THE DRAWINGS

Embodiments will now be described in more detail, and with reference to the accompanying drawings, in which:

FIG. 1 schematically illustrates a traditional server having various resources;

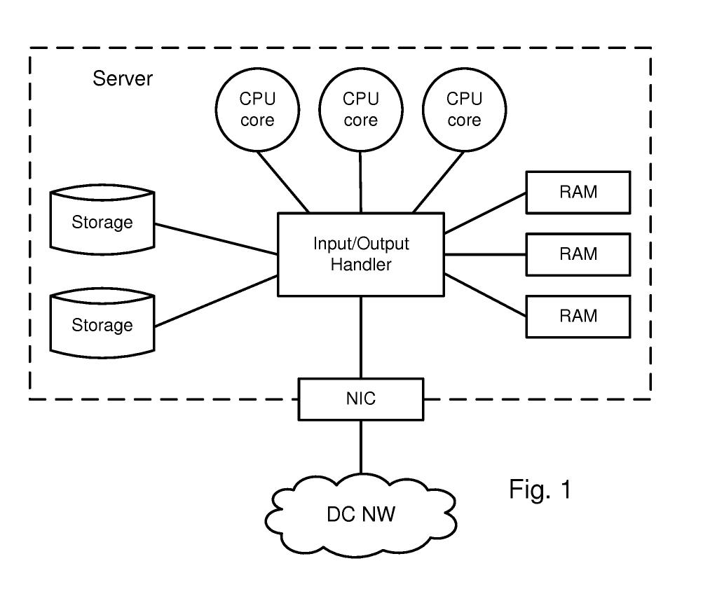

FIG. 2 schematically illustrates system blocks of hardware disaggregated architecture;

FIG. 3 presents a handshake diagram involving a processing arrangement according to embodiments of the present invention;

FIGS. 4 and 5 present actions of a method being performed in processing arrangement, according to some embodiments;

FIG. 6 schematically presents an embodiment of a pool of central processing units (CPUs), according to some embodiments; and

FIGS. 7 and 8 schematically present a processing arrangement according to different embodiments of the present invention.

### DETAILED DESCRIPTION

In the following description, exemplary embodiments will be described in more detail, with reference to accompanying drawings. For the purpose of explanation and not limitation, specific details are set forth, such as particular examples and techniques in order to provide a thorough understanding.

Modern processing arrangements, such as, CPUs have mechanisms to reduce power consumption, which enable shutting down one or more circuits of the processing arrangements.

The present disclosure relates to utilization of processing arrangements. It is herein proposed to make use of a processing arrangement instead of maintaining it in an idle state. When a processing arrangement enters an idle state, it is released from its current host. At this stage it is advantageous not to keep the processing arrangement in an idle state, but to make use of it. Instead of keeping it in an idle state, the processing arrangement may be advantageously used by another host in need of computational resources.

For instance, in a disaggregated architecture, when CPUs are set to an idle architectural state with deeper CPU C-state, they are released from their current host and the architectural state of the CPU is stored in a memory. When another host needs more computational power such as CPUs, these CPUs may be turned on attached to said another host.

The proposed embodiments herein introduce an approach to provide computational resources from, for instance, a data center with hardware resource disaggregation architecture, to hosts in need of increased computational resources. This is in contrast to legacy virtualization techniques, where computational resources are statically assigned to one or more hosts.

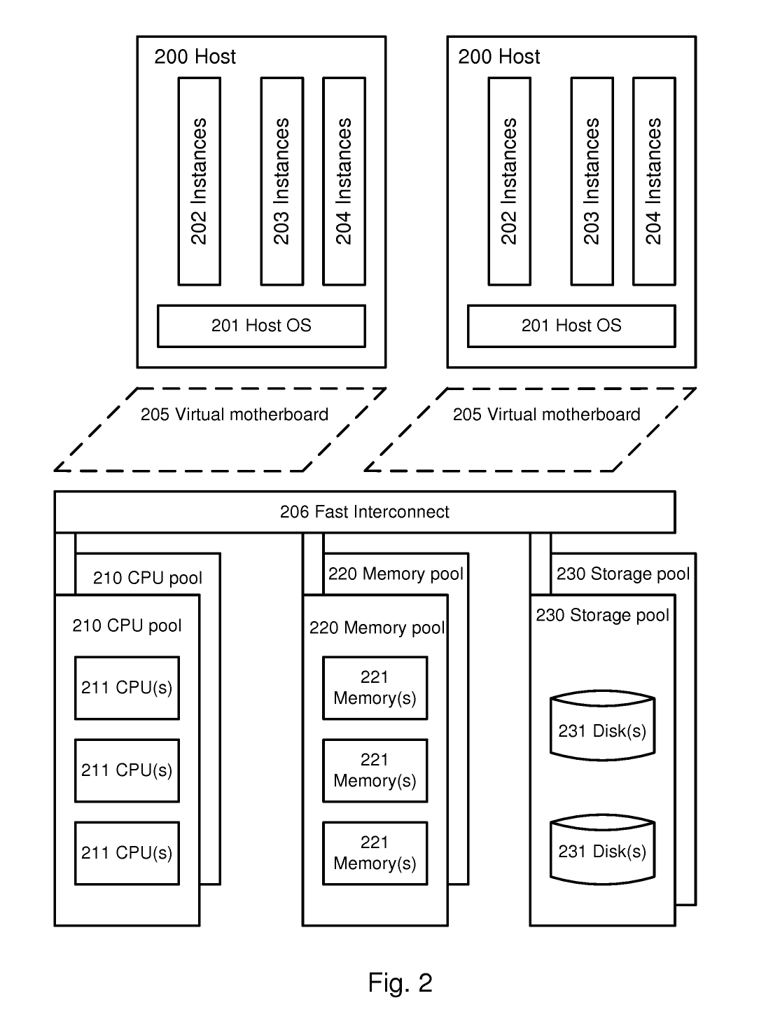

FIG. 2 schematically illustrates an embodiment of system blocks of a disaggregated computational architecture. Each host 200 may run a host operative systems (OS) 201 on its own for the computational instances 202, 203, 204.

Via a fast interconnect 206 various resources may be provided to individual virtual motherboards 205. Computational resources may be comprised of multiple CPU pools 210, where each CPU pool may comprise multiple CPUs 211.

Similarly the resources may comprise one or more memory pool 220, each having a multiple of memory units or memories 221. Also, the resources may also comprise one or more storage pools 230, each having one or more disks 231.

Portions of each CPU pool, memory pool and storage pool may thus be assigned to individual hosts via the virtual motherboards. The virtual motherboards may thus have assigned resources from different resource pools.

Each host 200 may hence use the resources assigned to each virtual motherboard. The host OS 201 may also employ virtualization technologies if applicable.

On top of the host OS, said one or more computational instances 202, 203, 204 may execute applications. It is noted that a computational instance may be a virtual container, a virtual machine (VM) or any other executable code.

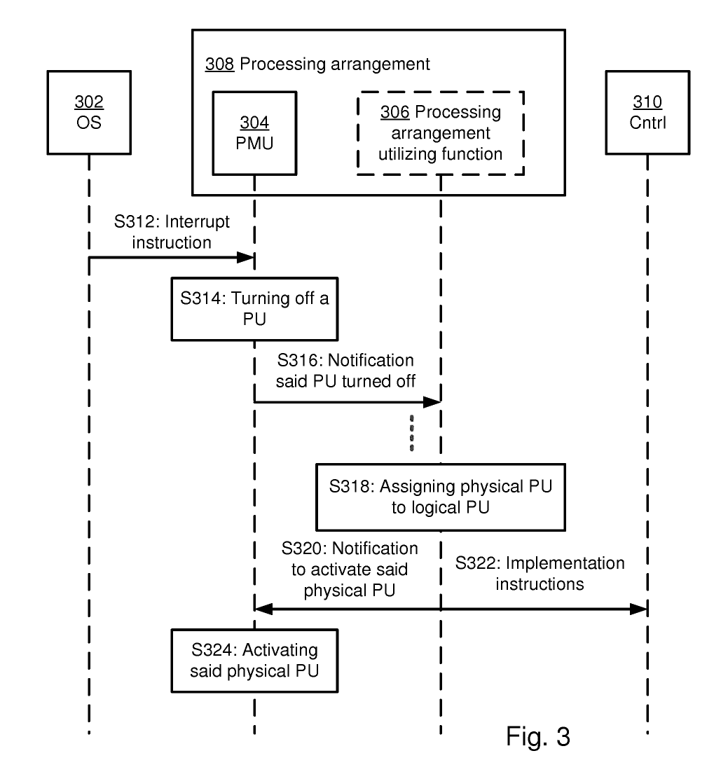

FIG. 3 presents a handshake diagram involving a host operative system (OS) 302, a processing arrangement 308, and a controller 310. The processing arrangement 308 comprises a power management unit (PMU) 304, and may also comprise a processing arrangement utilizing function 306. The processing arrangement utilizing function 306 may alternatively be located external to the processing arrangement 308.

In the case the processing arrangement is realized by a pool of CPUs, the processing arrangement utilizing function 306 may be comprised within the processing arrangement. In the case the processing arrangement is realized by a CPU, the processing arrangement utilizing function 306 may be located external to the processing arrangement.

In signaling action S312 the host OS sends an interrupt instruction to the PMU 304, instructing the PMU 304 to switch or turn off a processing unit (PU) of the processing arrangement 308. In action S314, PMU 304 thus switches or turns off the PU. In action S316, PMU 304 may send a notification to the processing arrangement utilization function 306 that the PU is switched or turned off. The processing arrangement utilization function 306 may therefore note that the PU is idle.

In action S318 the processing arrangement utilization function 306 assigns a physical PU of the processing arrangement to a logical PU. Action S318 is performed when said logical PU has instructions to be executed. Action S318 may thus not be performed until there are instructions to be executed by the logical PU. In this sense, action S318, i.e. the assigning of the physical PU to the logical PU, is not triggered by the foregoing action, action S316.

In the case the PU that was switched off was assigned to a logical PU, another PU that is idle may be assigned to the logical PU. Alternatively, said switched off PU may be assigned to another logical PU.

These are just a few examples of how to assign a physical PU to a logical PU for dynamic utilization of computational resources. The present disclosure shall not be construed to be limited to these, but may in addition also comprise assigning physical computational resources to two or more logical PUs, in need of physical computational resources.

In action S320 the processing arrangement utilizing function 306 sends a notification to the PMU 304, to activate one or more of said physical PUs. In action S322, processing arrangement utilizing function 306 sends implementing instructions to a controller 310 for implementing the assignment between the one of more said physical PUs and one or more logical PUs.

In action S324, the PMU 304 activates said one or more physical PUs.

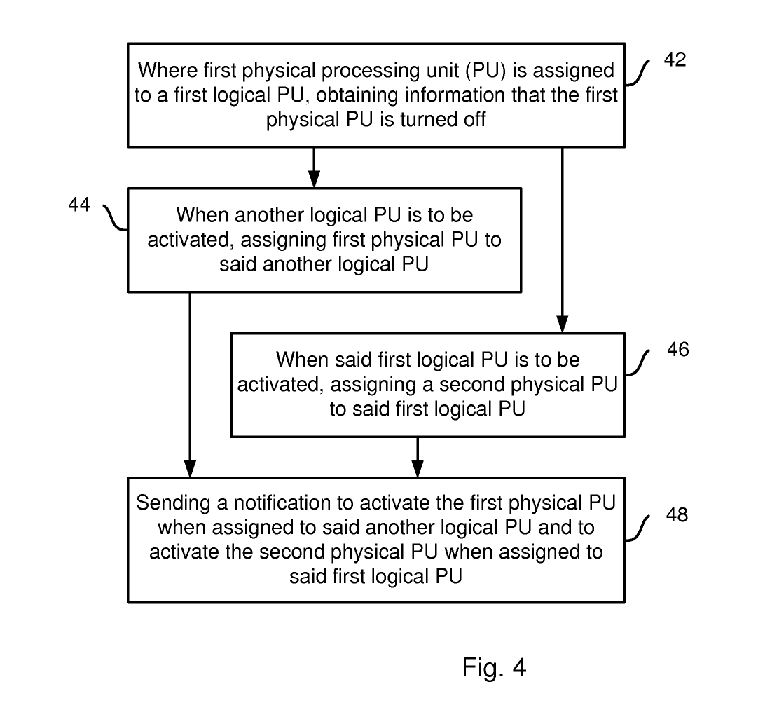

With reference to the flow chart of FIG. 4, a method for efficient utilization of a processing arrangement comprising at least a first and a second physical processing unit (PU), where the first physical PU is assigned to a first logical PU, is now described. The method comprises:

Action 42: Obtaining information that the first physical PU is turned off.

Obtaining information may comprise a receiving notification that the first physical processing unit is turned off.

Action 44: When another logical PU is to be activated, assigning said first physical PU to said another logical PU. Alternatively, the next action is performed.

Action 46: When said first logical PU is to be activated, assigning said second physical processing unit to the first logical processing unit.

Action 48: This action comprises sending to a power management unit, a notification to activate the first physical PU when being assigned to said another logical PU, and to activate the second physical PU when being assigned to said first logical PU

The method may further comprise storing a state of the first physical processing unit for the first logical processing unit into a first memory, prior to either assigning 44 said first physical processing unit to said another logical processing unit or assigning 46 said second physical processing unit to the first logical processing unit.

The method may further comprise copying a state to the first physical processing unit from a second memory for said another logical processing unit, prior to sending the notification to activate the first physical processing unit.

The method may further comprise checking that the second physical processing unit is idle, when said first logical processing unit is to be activated, and wherein sending the notification to the second physical processing unit is performed when the second physical processing unit is idle.

The method may also comprise copying the state of the first physical processing unit from the first memory to the second physical processing unit for the first logical processing unit, prior to sending the notification to the second physical processing unit.

The method may in addition comprise sending instructions to a controller for implementing either the assignment between said first physical processing unit to said another logical processing unit, or the assignment between said second physical processing unit to the first logical processing unit.

With reference to the flow chart of FIG. 5, an embodiment of method steps for efficient utilization of a processing arrangement comprising at least a first and a second physical PU, is now described. The method may be performed by a processing arrangement utilizing function. The method comprises:

Action 502: Where the first physical PU is assigned to a first logical PU, obtaining information that the first physical PU is turned off. Since the physical PU is tuned off, it is available to be used for other logical PUs.

Action 504: The state of the first physical PU for the first logical PU is stored in a memory. The state of the first physical PU is taken from a static memory, and may be stored in another memory region to avoid unintentional overwriting of the state.

Either performing actions 506 and 508, or performing actions 510-514:

Action 506: Said first physical PU is assigned to another logical PU, when said another logical PU is to be activated.

Action 508: Copying a state to the first physical PU from the memory, for said another logical PU, to the static memory of first physical PU.

Action 510: Assigning said second physical PU to the first logical PU, when said first logical PU is to be activated, in need to wake up.

Action 512: Checking that the second physical PU is idle, and when it is idle, continuing to actions 514 and 516.

Action 514: Copying the stored state of the first physical PU from the memory to the second physical PU, for the first logical PU.

The processing arrangement utilizing function may then send instructions to a controller such as a field programmable gate array, to reprogram wiring for the assignments between physical PUs and logical PUs.

Action 516: Sending, to a power management unit (PMU), a notification to activate the first physical PU when assigned to said another logical PU, and sensing a notification to activate the second physical PU, when assigned to the first logical PU, when the second physical PU is idle.

After an activate notification is sent to the PMU, the physical PU activated wakes up with within the next context.

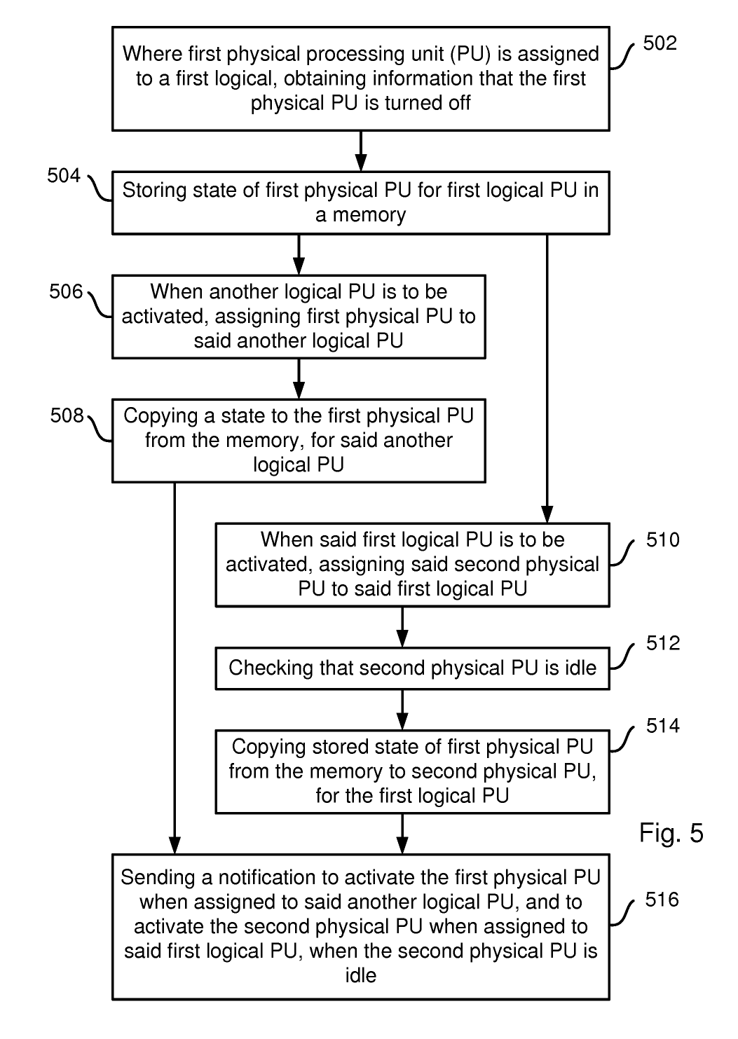

FIG. 6 schematically presents a general function block of a CPU Pool 211 as illustrated in FIG. 2. It is noted that this general function block has a non-specific architecture. The CPU pool of FIG. 6 comprises multiple of CPUs 602. Each CPU 602 has several processing units or CPU cores, in the form of core 1, 604 up to core N, 606. The CPU 602 further comprises one or more input/output nodes 608. The CPU 602 also comprises a power management unit (PMU) 610 and, as well as a memory controller 612. The CPU pool also has a controller 614 and a processing arrangement utilizing function 616. The processing arrangement utilizing function 616 may be responsible to store and keep the assignments between physical PU and logical PU and therefore also the state of sharing of the computational resources involved. The processing arrangement utilizing function 616 may also modify components of the CPU.

Each input/output node 608 may be typically responsible for communication between the CPU 602 and the CPU pool. The memory controller 612 may be responsible for managing access to the memory. The PMU 610 may be responsible for turning off different components when these are not used.

Instructions that trigger the PMU 610 to turn of physical PU comprise HALT and MWAIT. The HALT instruction stops instruction execution and places a physical PU or processor in HALT state. An enabled interrupt instruction, or reset, may resume execution. When an interrupt instruction, including enabled interrupt, is used to resume execution from a HALT state, an instruction pointer (CS:EIP) saved, points to the instruction following the HALT instruction.

The MWAIT instruction may be considered to be a hint allowing the physical PU or processor to stop instruction execution and enter an implementation-dependent optimized state until further events. The MWAIT instruction is architecturally similar to a no operation (NOP) instruction.

The controller 614 may be responsible for dynamically attaching the different components of a virtual motherboard 205 to the computational units or cores, as assigned to a particular host 200.

The controller 614 may communicate with the CPU 602 via the input/output node 608. The controller 614 may also communicate with the processing arrangement utilizing function 616

As mentioned above, the processing arrangement utilizing function 616 may reside within a CPU or within a CPU pool, but external to the CPUs, depending on the level of granularity.

Throughout this disclosure, a logical processing unit (PU) denotes a PU that is assigned to the host OS, whereas a physical PU denotes a PU that resides on a processor chipset.

The processing arrangement utilizing function may keep lists of various logical PUs. One list may comprise PUs currently executing instructions. These are denoted active PUs. The processing arrangement utilizing function may also keep a list of PUs, which are idle and do not have assigned any physical PUs. The processing arrangement utilizing function may also keep a list of logical PUs that need to wake up when a physical PU becomes available. These logical PUs may be denoted ready PUs.

When a power management unit (PMU) received an interrupt instruction, the PMU may change the state of a physical PU to a deep state that flushes all the caches of the physical PU and turns off the physical PU. A C-state of C6 may represent such a deep state. The PMU may then send a notification to a processing arrangement utilizing function that the physical PU is turned off. Thereafter, processing arrangement utilizing function may assign this physical PU to a logical PU of another host that needs more processing power. The processing arrangement utilizing function may programs a field programmable gate array (FPGA) controller that typically resides between the physical PU and a host and redirects signals to the logical PUs which belong or are assigned to the host.

In order for a physical PU to be available for being assigned to a logical PU, the physical PU may have to be turned off, and its state stored from a static memory to another memory by the processing arrangement utilizing function.

Since multiple processing units may be present in processing arrangement, such as multiple CPUs are available in CPU pools, statistical multiplexing of idle processing resources is advantageously utilized. Dynamicity of assignments of physical PU to logical PUs is hence increased. Logical hosts may thus share physical PUs from the same processing arrangement.

The present disclosure also comprises a processing arrangement utilizing function 306; 616 that is capable to efficiently utilize a processing arrangement 308; 602 that comprises at least a first physical processing unit (PU) 604 and a second 606 physical PU. The first physical PU is adapted to be assigned to a first logical PU. The processing arrangement utilizing function is configured to obtain information that the first physical PU is turned off. The processing arrangement utilizing function is also configured to, when another logical PU is to be activated, assign said first physical PU 604 to said another logical PU. The processing arrangement utilizing function is also configured to, when said first logical PU is to be activated, check that the second physical PU 606 is idle, and assign said second physical PU to the first logical PU.

In addition, the processing arrangement utilizing function is also configured to send, to a power management unit 304, a notification to activate the first physical processing unit 604 when being assigned to said another logical processing unit and to activate the second physical processing unit 606 when being assigned to said first logical processing unit.

The processing arrangement utilizing function 306; 616 may also be configured to receive a notification that the first physical processing unit is turned off.

The processing arrangement utilizing function 306; 616 may also be configured to store a state of the first physical processing unit for the first logical processing unit into a first memory.

The processing arrangement utilizing function 306; 616 may in addition be configured to copy a state to the first physical processing unit from a second memory for said another logical processing unit.

The processing arrangement utilizing function 306; 616 may further be configured to check that the second physical processing unit is idle, when said first logical processing unit is to be activated, and configured to send the notification to the second physical processing unit when the second physical processing unit is idle.

The processing arrangement utilizing function 306; 616 may further be configured to copy the state of the first physical processing unit from the first memory to the second physical processing unit for the first logical processing unit.

The processing arrangement utilizing function 306; 616 may further be configured to send instructions to a controller 614 for implementing either the assignment between said first physical processing unit to said another logical processing unit, or the assignment between said second physical processing unit to the first logical processing unit.

The processing arrangement utilizing function 306; 616 may further be adapted to be comprised within the processing arrangement.

The processing arrangement of the processing arrangement utilizing function 306; 616 may comprise a pool of central processing units, and the first and second physical processing units each may comprise a CPU 602.

The processing arrangement of the processing arrangement utilizing function 306; 616 may comprise a CPU 602, and the first and second physical processing units each may comprise a CPU core 604, 606.

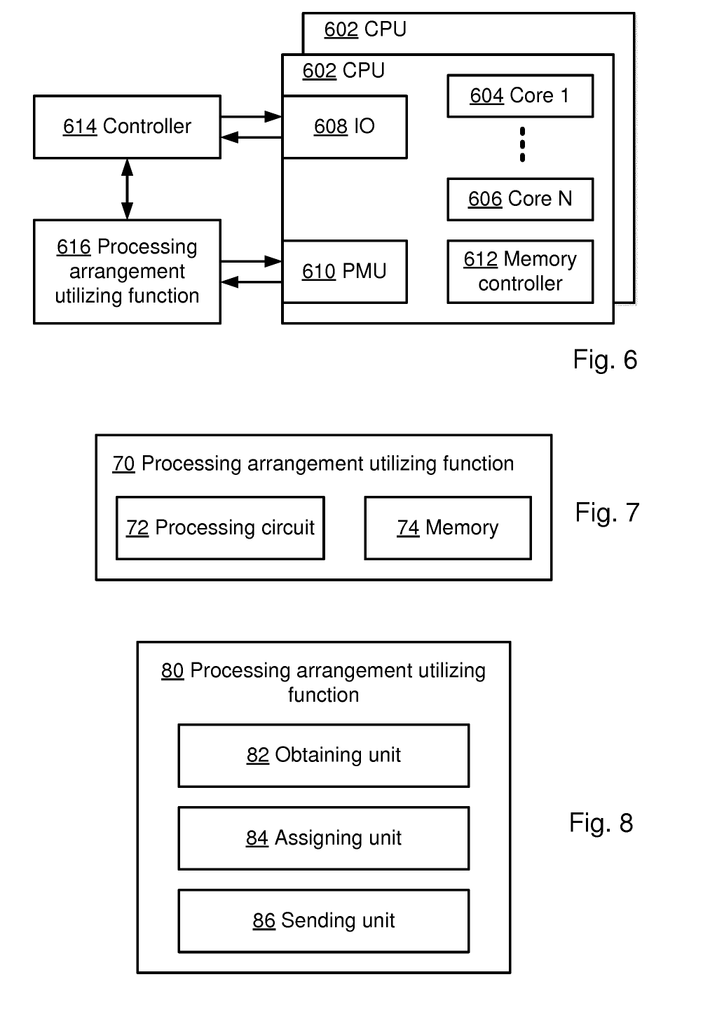

With reference to FIG. 7, an alternative embodiment of the processing arrangement utilizing function is presented. The processing arrangement utilizing function 70 is capable of efficiently utilizing a processing arrangement. The processing arrangement utilizing function comprises a processing circuit 72, and a memory 74. The memory contains instructions executable by said processing circuit 72 whereby said processing arrangement utilizing function 70 is operative to obtain information that the first physical processing unit is turned off.

The processing arrangement utilizing function 70 is also operative to, when another logical processing unit is to be activated, assign said first physical processing unit 604 to said another logical processing unit.

The processing arrangement utilizing function 70 is also operative to, when said first logical processing unit is to be activated, assign said second physical processing unit to the first logical processing unit.

In addition, the processing arrangement utilizing function 70 is operative to, send to a power management unit 304, a notification to activate the first physical processing unit 604 when being assigned to said another logical processing unit and to activate the second physical processing unit 606 when being assigned to said first logical processing unit.

In an alternative way to describe the processing arrangement utilizing function, FIG. 8 presents a processing arrangement utilizing function, 80 that is capable of efficiently utilizing a processing arrangement. The processing arrangement comprises at least a first 604 and a second 606 physical processing unit, where the first physical processing unit is adapted to be assigned to a first logical processing unit. The processing arrangement utilizing function 80 comprises an obtaining unit 82, an assigning unit 84, and a sending unit 86.

The obtaining unit 82 is configured to obtain information that the first physical processing unit is turned off.

The assigning unit 84 is configured to, when another logical processing unit is to be activated, assign said first physical processing unit 604 to said another logical processing unit; and when said first logical processing unit is to be activated, and assign said second physical processing unit to the first logical processing unit.

The sending unit 86 is configured to send, to a power management unit 304, a notification to activate the first physical processing unit 604 when being assigned to said another logical processing unit and to activate the second physical processing unit 606 when being assigned to said first logical processing unit.

The present disclosure also comprises a computer program, comprising instructions which, when executed on at least one processing circuit, cause the at least one processing circuit to carry out the method as above, for efficiently utilizing a processing arrangement.

The present disclosure also comprises a computer program product comprising computer-readable storage medium, having stored thereon a computer program, comprising instructions which, when executed on at least one processing circuit, cause the at least one processing circuit to carry out the method as above, for efficiently utilizing a processing arrangement.

Physical processing arrangements being idle may be assigned to other logical PU belonging to another host. Dynamic reassignment of a physical PU may be considered to be sharing of said physical PU among different hosts. Reassignment of physical PUs increases the utilization of processing arrangements and therefore also of datacenters without negatively affecting the processing performance of the physical PUs.

Exemplary embodiments as described herein have the following advantages:

They increase the utilization of processing arrangements, taking advantage of statistical multiplexing.

It may be further noted that the above described embodiments are only given as examples and should not be limiting to the present exemplary embodiments, since other solutions, uses, objectives, and functions are apparent within the scope of the embodiments as claimed in the accompanying patent claims.

Abbreviations

CPU central PU

DC data communication

FPGA field programmable gate array

NIC network interface card

NOP no operation

OS operative system

PMU power management unit

PU processing unit

RAM random access memory

VM virtual machine

VMM VM monitor

1. A method for efficient utilization of a processing arrangement comprising at least a first and a second physical processing unit, where the first physical processing unit is assigned to a first logical processing unit, the method comprises:
obtaining information that the first physical processing unit is turned off;
when another logical processing unit is to be activated, assigning said first physical processing unit to said another logical processing unit;
when said first logical processing unit is to be activated, assigning said second physical processing unit to the first logical processing unit; and
sending, to a power management unit, a notification to activate the first physical processing unit when being assigned to said another logical processing unit and to activate the second physical processing unit when being assigned to said first logical processing unit.

2. The method according to claim 1, wherein obtaining information comprises receiving a notification that the first physical processing unit is turned off.

3. The method according to claim 1, further comprising storing a state of the first physical processing unit for the first logical processing unit into a first memory, prior to either assigning said first physical processing unit to said another logical processing unit or assigning said second physical processing unit to the first logical processing unit.

4. The method according to claim 1, further comprising copying a state to the first physical processing unit from a second memory for said another logical processing unit, prior to sending the notification to activate the first physical processing unit.

5. The method according to claim 1, further comprising checking that the second physical processing unit is idle, when said first logical processing unit is to be activated, and wherein sending the notification to the second physical processing unit is performed when the second physical processing unit is idle.

6. The method according to claim 3, further comprising copying the state of the first physical processing unit from the first memory to the second physical processing unit for the first logical processing unit, prior to sending the notification to the second physical processing unit.

7. The method according to claim 1, further comprising sending instructions to a controller for implementing either the assignment between said first physical processing unit to said another logical processing unit, or the assignment between said second physical processing unit to the first logical processing unit.

8. A processing arrangement utilizing function capable to efficiently utilize a processing arrangement that comprises at least a first and a second physical processing unit, where the first physical processing unit is adapted to be assigned to a first logical processing unit, the processing arrangement utilizing function being configured to:
obtain information that the first physical processing unit is turned off;
when another logical processing unit is to be activated, assign said first physical processing unit to said another logical processing unit;
when said first logical processing unit is to be activated, assign said second physical processing unit to the first logical processing unit; and
send, to a power management unit, a notification to activate the first physical processing unit when being assigned to said another logical processing unit and to activate the second physical processing unit when being assigned to said first logical processing unit.

9. The processing arrangement utilizing function according to claim 8, further being configured to receive a notification that the first physical processing unit is turned off.

10. The processing arrangement utilizing function according to claim 8, further being configured to store a state of the first physical processing unit for the first logical processing unit into a first memory.

11. The processing arrangement utilizing function according to claim 8, further being configured to copy a state to the first physical processing unit from a second memory for said another logical processing unit.

12. The processing arrangement utilizing function according to claim 8, further being configured to check that the second physical processing unit is idle, when said first logical processing unit is to be activated, and configured to send the notification to the second physical processing unit when the second physical processing unit is idle.

13. The processing arrangement utilizing function according to claim 10, further being configured to copy the state of the first physical processing unit from the first memory to the second physical processing unit for the first logical processing unit.

14. The processing arrangement utilizing function according to claim 8, further being configured to send instructions to a controller for implementing either the assignment between said first physical processing unit to said another logical processing unit, or the assignment between said second physical processing unit to the first logical processing unit.

15. The processing arrangement utilizing function according to claim 8, further being adapted to be comprised within the processing arrangement.

16. The processing arrangement utilizing function according to claim 8, wherein the processing arrangement comprises a pool of central processing units, CPUs, and the first and second physical processing units each comprises a CPU.

17. The processing arrangement utilizing function according to claim 8, wherein the processing arrangement comprises a CPU, and the first and second physical processing units each comprises a CPU core.

18. A processing arrangement utilizing function capable to efficiently utilize a processing arrangement that comprises at least a first and a second physical processing unit, where the first physical processing unit is adapted to be assigned to a first logical processing unit, the processing arrangement utilizing function comprising a processing circuit and a memory, said memory containing instructions executable by said processing circuit whereby said processing arrangement utilizing function is operative to:
obtain information that the first physical processing unit is turned off;
when another logical processing unit is to be activated, assign said first physical processing unit to said another logical processing unit;
when said first logical processing unit is to be activated, assign said second physical processing unit to the first logical processing unit; and
send, to a power management unit, a notification to activate the first physical processing unit when being assigned to said another logical processing unit and to activate the second physical processing unit when being assigned to said first logical processing unit.

19. A computer program, comprising computer readable code which when run on at least one processing circuit, causes the at least one processing circuit to carry out the method according to claim 1.

20. A computer program product comprising a computer-readable storage medium and a computer program according to claim 19, wherein the computer program is stored on the computer-readable storage medium.
